(19) United States
(12) Patent Application Publication
(10) Pub. No.: US 2021/0016390 A1
(43) Pub. Date: Jan. 21, 2021

(54) OPTICAL PULSE STRETCHER, LASER APPARATUS, AND METHOD FOR MANUFACTURING ELECTRONIC DEVICE

(71) Applicant: Gigaphoton Inc., Tochigi (JP)

(72) Inventor: Koji ASHIKAWA, Oyama-shi (JP)

(73) Assignee: Gigaphoton Inc., Tochigi (JP)

(21) Appl. No.: 17/061,796

(22) Filed: Oct. 2, 2020

Related U.S. Application Data
(63) Continuation of application No. PCT/JP2018/020423, filed on May 28, 2018.

(51) Int. Cl. B23K 26/0622

(52) U.S. Cl. CPC B23K 26/0622; B23K 2101/36

(57) ABSTRACT

An optical pulse stretcher includes a separation optical element configured to separate pulsed laser light incident on a first surface thereof into first transmitted light and first reflected light, a reflective optical system configured to guide the first reflected light to be incident on a second surface of the separation optical element that is the surface opposite the first surface, and a holding member that has a through hole having an opening area smaller than the area of a reflective surface of a reflective optical element provided in the reflective optical system, is disposed on the rear side of the reflective optical element, and is configured to hold the reflective optical element.

### CROSS-REFERENCE TO RELATED APPLICATIONS

The present application is a continuation application of International Application No. PCT/JP2018/020423, filed on May 28, 2018, the entire contents of which are hereby incorporated by reference.

### BACKGROUND

### 1. Technical Field

The present disclosure relates to an optical pulse stretcher, a laser apparatus, and a method for manufacturing an electronic device.

### 2. Related Art

A laser annealer is an apparatus configured to irradiate an amorphous silicon film deposited on a glass substrate with pulsed laser light outputted from a laser apparatus, such as an excimer laser, and having a wavelength that belongs to the ultraviolet region to modify the amorphous silicon film into a polysilicon film. Modifying the amorphous silicon film into the polysilicon film allows production of a thin film transistor (TFT). The TFT is used in a relatively large liquid crystal display.

### CITATION LIST

### Patent Literature

### [PTL 1] JP-A-2005-148549

### [PTL 2] JP-A-2002-075831

### [PTL 3] US Patent Application Publication No. 2007/0280308

### SUMMARY

An optical pulse stretcher according to a viewpoint of the present disclosure includes a separation optical element configured to separate pulsed laser light incident on a first surface thereof into first transmitted light and first reflected light, a reflective optical system configured to guide the first reflected light to be incident on a second surface of the separation optical element that is a surface opposite the first surface, and a holding member that has a through hole having an opening area smaller than an area of a reflective surface of a reflective optical element provided in the reflective optical system, is disposed on a rear side of the reflective optical element, and is configured to hold the reflective optical element.

A laser apparatus according to another viewpoint of the present disclosure includes a laser resonator, a laser chamber disposed in the laser resonator and configured to accommodate a laser gas, a pair of discharge electrodes disposed in the laser chamber, and an optical pulse stretcher disposed in an optical path of pulsed laser light outputted from the laser resonator. The optical pulse stretcher includes a separation optical element configured to separate the pulsed laser light incident on a first surface thereof into first transmitted light and first reflected light, a reflective optical system configured to guide the first reflected light to be incident on a second surface of the separation optical element that is a surface opposite the first surface, and a holding member that has a through hole having an opening area smaller than an area of a reflective surface of a reflective optical element provided in the reflective optical system, is disposed on a rear side of the reflective optical element, and is configured to hold the reflective optical element.

A method for manufacturing an electronic device according to another viewpoint of the present disclosure includes producing pulsed laser light by using a laser apparatus, outputting the pulsed laser light to a laser annealer, and irradiating a substrate with the pulsed laser light in the laser annealer to manufacture an electronic device. The laser apparatus includes a laser resonator, a laser chamber disposed in the laser resonator and configured to accommodate a laser gas, a pair of discharge electrodes disposed in the laser chamber, and an optical pulse stretcher disposed in an optical path of the pulsed laser light outputted from the laser resonator. The optical pulse stretcher includes a separation optical element configured to separate the pulsed laser light incident on a first surface thereof into first transmitted light and first reflected light, a reflective optical system configured to guide the first reflected light to be incident on a second surface of the separation optical element that is a surface opposite the first surface, and a holding member that has a through hole having an opening area smaller than an area of a reflective surface of a reflective optical element provided in the reflective optical system, is disposed on a rear side of the reflective optical element, and is configured to hold the reflective optical element.

### BRIEF DESCRIPTION OF THE DRAWINGS

Embodiments of the present disclosure will be described below only by way of example with reference to the accompanying drawings.

FIG. 1 diagrammatically shows the configurations of a laser apparatus 1 and a laser annealer 40 according to Comparative Example.

FIG. 2A schematically shows the configuration of an optical pulse stretcher 16a in a first embodiment of the present disclosure. FIG. 2B is an enlarged view showing the beam cross section taken along the line IIB-IIB in FIG. 2A and holders viewed from a position on the line IIB-IIB. FIG. 2C is an enlarged view showing the beam cross section taken along the line IIC-IIC in FIG. 2A and the holders viewed from a position on the line IIC-IIC. FIG. 2D is an enlarged view showing the beam cross section taken along the line IID-IID in FIG. 2A.

FIG. 3 shows beam cross sections and holders in a first variation of the first embodiment of the present disclosure.

FIG. 4 shows beam cross sections and holders in a second variation of the first embodiment of the present disclosure.

FIG. 5 shows beam cross sections and holders in a third variation of the first embodiment of the present disclosure.

FIG. 6 schematically shows the configuration of an optical pulse stretcher 16e in a first example of a second embodiment of the present disclosure.

FIG. 7 schematically shows the configuration of an optical pulse stretcher 16f in a second example of the second embodiment of the present disclosure.

FIG. 8 schematically shows the configuration of an optical pulse stretcher 16g in a third example of the second embodiment of the present disclosure.

FIG. 9 schematically shows the configuration of an optical pulse stretcher 16h in a fourth example of the second embodiment of the present disclosure.

FIG. 10 schematically shows the configuration of part of an optical pulse stretcher 16i in a fifth example of the second embodiment of the present disclosure.

FIG. 11 schematically shows the configuration of part of an optical pulse stretcher 16j in a sixth example of the second embodiment of the present disclosure.

FIG. 12 schematically shows the configuration of an optical pulse stretcher 16k in a seventh example of the second embodiment of the present disclosure.

FIG. 13 schematically shows the configuration of an optical pulse stretcher 16m in an eighth example of the second embodiment of the present disclosure.

FIG. 14 schematically shows the configuration of a cooling water pipe used in the first, third, fifth, and seventh examples of the second embodiment of the present disclosure.

FIG. 15 schematically shows the configuration of heat dissipating fins in the second, fourth, sixth and eighth examples of the second embodiment of the present disclosure.

### DETAILED DESCRIPTION

<Contents>

### 1. Comparative Example

### 1.1 Configuration

1.1.1 Laser chamber
1.1.2 Optical pulse stretcher
1.1.3 Pulse energy measurement section
1.1.4 Laser annealer

### 1.2 Operation

### 1.2.1 Controller

1.2.2 Laser chamber
1.2.3 Optical pulse stretcher
1.2.4 Pulse energy measurement section

### 1.2.5 Ventilator

1.2.6 Laser annealer

### 1.3 Problems

2. Optical pulse stretcher in which holders each having through hole hold concave mirrors

### 2.1 Configuration

### 2.2 Operation

2.3 First variation of shape of opening sections
2.4 Second variation of shape of opening sections
2.5 Third variation of shape of opening sections
2.6 Other variations
3. Optical pulse stretcher including cooling mechanism provided in enclosure
3.1 Case where cooling plates each having cooling medium channel are attached to enclosure
3.2 Case where cooling plates each including heat dissipating fins are attached to enclosure
3.3 Case where cooling plates each having cooling medium channel are disposed at openings of enclosure
3.4 Case where cooling plates each including heat dissipating fins are disposed at openings of enclosure
3.5 Cooling plate including cooling medium channel and optical damper
3.6 Cooling plate including heat dissipating fins and optical damper
3.7 Case where cooling medium channels are formed in enclosure
3.8 Case where heat dissipating fins are formed on enclosure
3.9 Example of cooling water pipe
3.10 Direction of grooves formed by heat dissipating fins

### 4. Supplementation

Embodiments of the present disclosure will be described below in detail with reference to the drawings. The embodiments described below show some examples of the present disclosure and are not intended to limit the contents of the present disclosure. Further, all configurations and operations described in the embodiments are not necessarily essential as configurations and operations in the present disclosure. The same component has the same reference character, and no redundant description of the same component will be made.

### 1. Comparative Example

### 1.1 Configuration

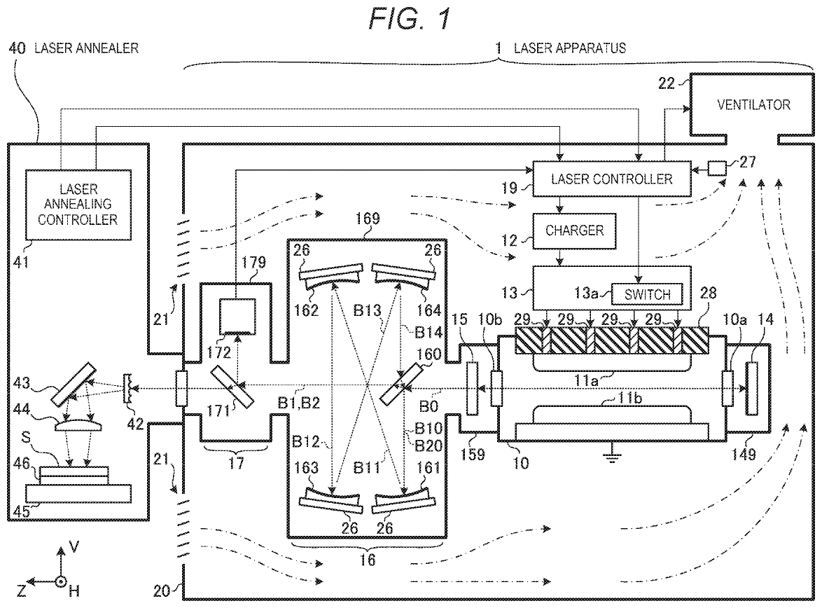

FIG. 1 diagrammatically shows the configurations of a laser apparatus 1 and a laser annealer 40 according to Comparative Example. The laser apparatus 1 shown in FIG. 1 includes a laser chamber 10, discharge electrodes 11a and 11b, a charger 12, a pulse power module (PPM) 13, a rear mirror 14, and an output coupling mirror 15. The laser apparatus 1 further includes an optical pulse stretcher 16, a pulse energy measurement section 17, a laser controller 19, and an enclosure 20. The laser apparatus 1 is an excimer laser apparatus configured to output pulsed laser light that belongs to the ultraviolet region and enters an external apparatus, such as the laser annealer 40.

FIG. 1 shows the laser apparatus 1 viewed along a direction perpendicular to the direction of the discharge between the discharge electrodes 11a and 11b. The traveling direction of the pulsed laser light outputted from the laser apparatus 1 is a direction +Z. The direction of the discharge between the discharge electrodes 11a and 11b is a direction +V or −V. The direction −V substantially coincides with the direction of gravity. A direction H is the direction perpendicular to both the directions Z and V. When it is unnecessary to distinguish the positive and negative sides from each other, the positive and negative signs are omitted.

1.1.1 Laser Chamber

The laser chamber 10 encapsulates a laser gas containing, for example, an argon gas or a krypton gas as a rare gas, a fluorine gas or a chlorine gas as a halogen gas, and a neon gas or a helium gas as a buffer gas.

Windows 10a and 10b are provided at opposite ends of the laser chamber 10. An opening is formed in the laser chamber 10, and an electric insulator 28 closes the opening. A plurality of electrical conductors 29 are buried in the electric insulator 28.

The discharge electrodes 11a and 11b are disposed in the laser chamber 10. The discharge electrode 11a is supported by the electric insulator 28 and electrically connected to the electrical conductors 29. The discharge electrode 11b is supported by a constituent member of the laser chamber 10 and electrically connected thereto. The constituent member of the laser chamber 10 is connected to ground potential.

The pulse power module 13 is connected to the electrical conductors 29. The pulse power module 13 includes a charging capacitor that is not shown and a switch 13a. The charging capacitor of the pulse power module 13 is connected to the charger 12.

The rear mirror 14 and the output coupling mirror 15 form a laser resonator. The rear mirror 14 includes a high-reflectance film. The rear mirror 14 is located outside the laser chamber 10 and accommodated in an enclosure 149. The output coupling mirror 15 includes a partially reflective film formed on a transparent substrate. The output coupling mirror 15 is located outside the laser chamber 10 and accommodated in an enclosure 159.

1.1.2 Optical Pulse Stretcher

The optical pulse stretcher 16 is disposed in the optical path of the pulsed laser light outputted via the output coupling mirror 15. The optical pulse stretcher 16 includes a beam splitter 160 and first to fourth concave mirrors 161 to 164. The beam splitter 160 and the first to fourth concave mirrors 161 to 164 are accommodated in an enclosure 169.

The beam splitter 160 is formed of a CaF₂ substrate configured to transmit the pulsed laser light at high transmittance. A first surface of the beam splitter 160 is coated with a partially reflective film configured to reflect part of the pulsed laser light and transmit the other part thereof, and a second surface of the beam splitter 160 that is the surface opposite the first surface is coated with an antireflection film configured to transmit the pulsed laser light at high transmittance. The beam splitter 160 corresponds to the separation optical element in the present disclosure. The first to fourth concave mirrors 161 to 164 form the reflection optical system in the present disclosure. The first to fourth concave mirrors 161 to 164 each correspond to the reflective optical element in the present disclosure. The first to fourth concave mirrors 161 to 164 are held by holders 26 disposed on the rear side of the first to fourth concave mirrors 161 to 164. The holders 26 are fixed to a wall surface of the enclosure 169 that is the wall surface parallel to the plane of view.

The enclosure 169 is made, for example, of aluminum on which nickel is plated. Nickel plating forms a stable layer even when the surface is oxidized, and the layer is unlikely to peel off and produce dust, whereby degradation of the reflective optical elements and other components in the enclosure 169 is suppressed. Gold or platinum may instead be used as the chemically stable metal.

1.1.3 Pulse Energy Measurement Section

The pulse energy measurement section 17 is disposed in the optical path of the pulsed laser light having passed through the optical pulse stretcher 16. The pulse energy measurement section 17 includes a beam splitter 171 and an optical sensor 172. The beam splitter 171 and the optical sensor 172 are accommodated in an enclosure 179. The interiors of the enclosures 159, 169, and 179 communicate with each other.

The laser chamber 10 and the enclosures 149, 159, 169, and 179 are accommodated in the enclosure 20. The enclosure 20 includes an intake port 21, a ventilator 22, and a wind speed sensor 27.

1.1.4 Laser Annealer

The laser annealer 40 includes a laser annealing controller 41, a fly-eye lens 42, a high-reflectance mirror 43, a condenser optical system 44, a drive mechanism 45, and a table 46. The fly-eye lens 42 includes a large number of lenses formed on a transparent substrate. The fly-eye lens 42 and the condenser optical system 44 form a Koehler illumination system. A radiation receiving object S, such as a glass substrate on which an amorphous silicon film is deposited, is mounted on the table 46. The drive mechanism 45 is configured to be capable of moving the table 46 in the HZ plane.

### 1.2 Operation

1.2.1 Controller

The laser annealing controller 41 provided in the laser annealer 40 is configured to control the drive mechanism 45 and other components of the laser annealer 40. The laser annealing controller 41 is configured to transmit a target pulse energy setting signal and an oscillation trigger signal to the laser apparatus 1.

The laser controller 19 provided in the laser apparatus 1 is configured to receive the target pulse energy setting signal and the oscillation trigger signal from the laser annealing controller 41. The laser controller 19 is configured to set voltage that charges the charger 12 based on the target pulse energy setting signal. The laser controller 19 is configured to transmit a trigger signal to the switch 13a of the pulse power module 13 based on the oscillation trigger signal.

Upon receipt of the trigger signal from the laser controller 19, the pulse power module 13 generates pulsed high voltage from the electric energy charged in the charger 12 and applies the high voltage between the discharge electrodes 11a and 11b.

1.2.2 Laser chamber

When the high voltage is applied between the discharge electrodes 11a and 11b, discharge occurs between the discharge electrodes 11a and 11b. The energy of the discharge excites the laser gas in the laser chamber 10, and the laser gas transitions to a high energy level. Thereafter, when the excited laser gas transitions to a low energy level, the laser gas emits light having a wavelength according to the difference between the energy levels. The light generated in the laser chamber 10 exits out of the laser chamber 10 via the windows 10a and 10b.

The light having exited out of the laser chamber 10 travels back and forth between the rear mirror 14 and the output coupling mirror 15 and is amplified whenever the light passes through a laser gain space between the discharge electrodes 11a and 11b. Part of the amplified light is outputted as the pulsed laser light via the output coupling mirror 15.

1.2.3 Optical pulse stretcher

The pulsed laser light having exited via the output coupling mirror 15 is incident as incident light B0 on the first surface of the beam splitter 160 along the direction +Z. Part of the incident light B0 passes through the first surface of the beam splitter 160, further passes through the second surface thereof, and therefore exits as first transmitted light B1 via the second surface along the direction +Z. The other part of the incident light B0 is reflected off the first surface of the beam splitter 160 and travels as first reflected light B10 from the first surface along the direction −V.

The first to fourth concave mirrors 161 to 164 are configured to sequentially reflect the first reflected light B10 as reflected light B11, B12, B13, and B14 and cause the reflected light B14 to be incident on the second surface of the beam splitter 160 along the direction −V. At least part of the reflected light B14 incident on the second surface of the beam splitter 160 along the direction −V passes through the second surface of the beam splitter 160, is reflected off the first surface of the beam splitter 160, passes through the second surface again, and exits as second reflected light B2 along the direction +Z. The first to fourth concave mirrors 161 to 164 are so disposed that the first reflected light B10 reflected off the first surface of the beam splitter 160 is transferred to the first surface of the beam splitter 160 via the first to fourth concave mirrors 161 to 164. The optical paths of the first transmitted light B1 and the second reflected light B2 are thus superimposed with each other.

The first transmitted light B1 and the second reflected light B2 have a time difference therebetween according to the optical path length of the detour optical path formed by the first to fourth concave mirrors 161 to 164. The optical pulse stretcher 16 is configured to superimpose the optical paths of the first transmitted light B1 and the second reflected light B2 to extend the pulse width of the pulsed laser light.

The other part of the reflected light B14 incident on the second surface of the beam splitter 160 along the direction −V may exit as second transmitted light B20 via the first surface of the beam splitter 160 along the direction −V and follow the detour optical path described above again.

1.2.4 Pulse Energy Measurement Section

The beam splitter 171 provided in the pulse energy measurement section 17 is configured to transmit the pulsed laser light having passed through the optical pulse stretcher 16 at high transmittance toward the laser annealer 40 and reflect part of the pulsed laser light toward the light receiving surface of the optical sensor 172. The optical sensor 172 detects the pulse energy of the pulsed laser light incident on the light receiving surface thereof and outputs data on the detected pulse energy to the laser controller 19.

The laser controller 19 is configured to control the voltage that charges the charger 12 based on the data on the pulse energy received from the pulse energy measurement section 17. Feedback control is thus performed on the pulse energy of the pulsed laser light.

1.2.5 Ventilator

The ventilator 22 is configured to exhaust the air in the enclosure 20. The exhausted air is replaced with new air that flows into the enclosure 20 via the intake port 21. The gas flow indicated by the dashed line arrows thus occurs in the enclosure 20, and the interior of the enclosure 20 is ventilated. The wind speed sensor 27 is configured to measure the speed of the gas flow in the enclosure 20 and transmit measured data to the laser controller 19. The laser controller 19 is configured to control the ventilator 22 based on the measured speed of the gas flow.

1.2.6 Laser Annealer

In the laser annealer 40, the fly-eye lens 42 and the condenser optical system 44 are configured to homogenize the optical intensity distribution of the pulsed laser light at the surface of the radiation receiving object S. The drive mechanism 45 is configured to move the table 46 at a predetermined speed in such a way that each predetermined position on the radiation receiving object S is irradiated with the pulsed laser light. When the glass substrate on which the amorphous silicon film has been deposited is irradiated with the pulsed laser light having a predetermined pulse width and a predetermined intensity, part of the amorphous silicon film is melted. The melted amorphous silicon film then crystalizes and is modified into a polysilicon film. An electronic device including a TFT can thus be manufactured.

### 1.3 Problems

Part of the pulsed laser light incident on the first to fourth concave mirrors 161 to 164 of the optical pulse stretcher 16 passes through the reflective surfaces of the first to fourth concave mirrors 161 to 164 in some cases. The energy of the pulsed laser light having passed through the reflective surfaces is absorbed by the holders 26 and raises the temperature of the holders 26. When the temperature of the holders 26 increases so that the holders 26 undergo thermal expansion or deformation, the positions or attitudes of the first to fourth concave mirrors 161 to 164 change. When the positions or attitudes of the first to fourth concave mirrors 161 to 164 change, the optical path axes of the light reflected off the mirrors undesirably shift. For example, the optical path axes of the first transmitted light B1 and the second reflected light B2 do not coincide with each other in some cases.

In embodiments described below, holders each having a through hole are configured to hold the first to fourth concave mirrors 161 to 164. Even when part of the pulsed laser light passes through the reflective surfaces of the first to fourth concave mirrors 161 to 164, an increase in the temperature of the holders can be suppressed because the transmitted light passes through the through holes of the holders.

### 2. Optical Pulse Stretcher in which Holders Each Having Through Hole Hold Concave Mirrors

### 2.1 Configuration

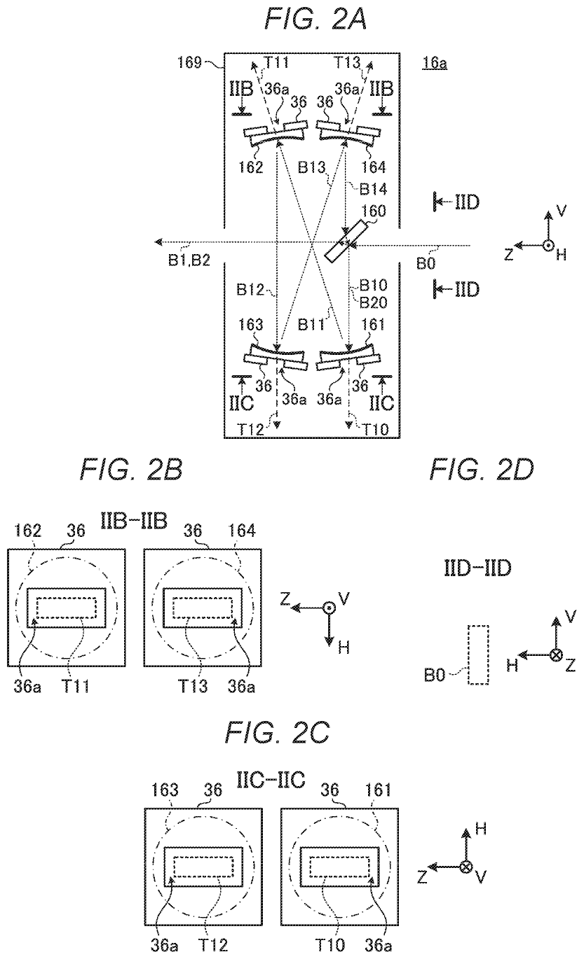

FIG. 2A schematically shows the configuration of an optical pulse stretcher 16a in a first embodiment of the present disclosure. FIG. 2B is an enlarged view showing the beam cross section taken along the line IIB-IIB in FIG. 2A and holders 36 viewed from a position on the line IIB-IIB. FIG. 2C is an enlarged view showing the beam cross section taken along the line IIC-IIC in FIG. 2A and the holders 36 viewed from a position on the line IIC-IIC. FIG. 2D is an enlarged view showing the beam cross section taken along the line IID-IID in FIG. 2A. In FIGS. 2B and 2C, the outer shape of each of the concave mirrors 161 to 164 is drawn with the dashed-dotted line.

In the first embodiment, the holders 36, which are configured to hold the first to fourth concave mirrors 161 to 164, each have a through hole 36a. The holders 36 correspond to the holding member in the present disclosure.

The incident light B0 has an oblong beam cross section having a beam width in the direction V longer than the beam width in the direction H, as shown in FIG. 2D. The cross-sectional shape of the beam corresponds to the shape of the laser gain space between the discharge electrodes 11a and 11b.

Part of the first reflected light B10 incident on the first concave mirror 161 passes as transmitted light T10 through the first concave mirror 161 in some cases.

Part of the reflected light B11 incident on the second concave mirror 162 passes as transmitted light T11 through the second concave mirror 162 in some cases.

Part of the reflected light B12 incident on the third concave mirror 163 passes as transmitted light T12 through the third concave mirror 163 in some cases.

Part of the reflected light B13 incident on the fourth concave mirror 164 passes as transmitted light T13 through the fourth concave mirror 164 in some cases.

The transmitted light T10 to T13 has an oblong beam cross section having a beam width in the direction Z longer than the beam width in the direction H, as shown in FIGS. 2B and 2C. The cross-sectional shape of the beam corresponds to the shape of the incident light B0 rotated by the beam splitter 160 around an axis parallel to the direction H by 90 degrees.

The opening section of the through hole 36a of each of the holders 36 has a shape having an opening width in the direction Z longer than the opening width in the direction H. The longitudinal directions of the opening sections of the through holes 36a of the holders 36 are all the direction Z and the same direction. In the example shown in FIGS. 2B and 2C, the opening section of the through hole 36a of each of the holders 36 has an oblong shape. The same direction does not mean the same direction in the exact sense. For example, even in a case where the first to fourth concave mirrors 161 to 164 are so disposed as to incline with respect to one another to form a loop-shaped detour optical path, the longitudinal directions of the opening sections of the through holes 36a of the holders 36 only need to be substantially the same direction. The oblong shape may not be an oblong shape according to the exact mathematical definition. For example, the oblong shape may have rounded corners, as described later.

The other points are the same as those in Comparative Example described above.

### 2.2 Operation

The configuration described above allows the transmitted light T10 to T13 to pass through the through holes 36a of the mirror holders 36. An increase in the temperature of the holders 36 is thus suppressed.

The opening area of each of the through holes 36a is greater than the beam cross-sectional area of the incident light B0 outputted from the laser resonator and entering the optical pulse stretcher 16a. The opening area of the through hole 36a is greater than the beam cross-sectional area of the transmitted light T10 to T13. A situation in which part of the transmitted light T10 to T13 hits the holders 36 is suppressed, whereby an increase in the temperature of the holders 36 is suppressed.

The suppression of an increase in the temperature of the holders 36 stabilizes the positions and attitudes of the first to fourth concave mirrors 161 to 164 and therefore stabilizes the optical path axes of the first transmitted light B1 and the second reflected light B2. The optical path axes of the first transmitted light B1 and the second reflected light B2 can thus be maintained coaxial with each other.

The opening area of each of the through holes 36a is smaller than the area of the reflective surface of each of the first to fourth concave mirrors 161 to 164, as shown in FIGS. 2B and 2C. The rear surfaces of the first to fourth concave mirrors 161 to 164 that are the surfaces opposite the reflective surfaces can thus be reliably held by the holders 36.

### 2.3 First Variation of Shape of Opening Sections

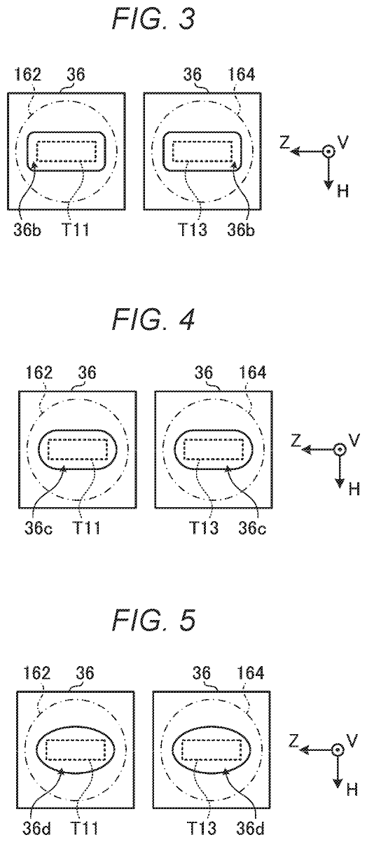

FIG. 3 shows beam cross sections and holders in a first variation of the first embodiment of the present disclosure. FIG. 3 is an enlarged view showing the beam cross sections taken along the line IIB-IIB in FIG. 2A and the holders viewed from a position on the line IIB-IIB, as in FIG. 2B.

In the example shown in FIG. 3, the opening section of a through hole 36b of each of the holders 36 has an oblong shape having rounded corners. The four corners of the oblong shape of the opening section of each of the through holes 36b may all be rounded.

The other points are the same as those described with reference to FIGS. 2A to 2D.

### 2.4 Second Variation of Shape of Opening Sections

FIG. 4 shows beam cross sections and holders in a second variation of the first embodiment of the present disclosure. FIG. 4 is an enlarged view showing the beam cross sections taken along the line IIB-IIB in FIG. 2A and the holders viewed from a position on the line IIB-IIB, as in FIG. 2B.

In the example shown in FIG. 4, a through hole 36c of each of the holders 36 is an oval hole. The oval hole refers to an elongated hole. The opposite ends of the opening section of the oval hole may be rounded.

The other points are the same as those described with reference to FIGS. 2A to 2D.

### 2.5 Third Variation of Shape of Opening Sections

FIG. 5 shows beam cross sections and holders in a third variation of the first embodiment of the present disclosure. FIG. 5 is an enlarged view showing the beam cross sections taken along the line IIB-IIB in FIG. 2A and the holders viewed from a position on the line IIB-IIB, as in FIG. 2B.

In the example shown in FIG. 5, the opening section of a through hole 36d of the each of the holes 36 has an elliptical shape. The elliptical shape may not be an elliptical shape according to the exact mathematical definition.

The other points are the same as those described with reference to FIGS. 2A to 2D.

### 2.6 Other Variations

The first embodiment has been described with reference to the case where the through holes are formed in the holders 36 that hold the first to fourth concave mirrors 161 to 164, but not necessarily in the present disclosure. A through hole only needs to be formed in the holder 36 that holds at least one of the first to fourth concave mirrors 161 to 164. For example, in a case where a shift of the position of an upstream mirror in the optical path of the pulsed laser light out of the first to fourth concave mirrors 161 to 164 greatly affects the shift of the optical axis, it is desirable to form a through hole in the holder 36 that holds the first concave mirror 161.

### 3. Optical Pulse Stretcher Including Cooling Mechanism Provided in Enclosure

3.1 Case where Cooling Plates Each Having Cooling Medium Channel are Attached to Enclosure

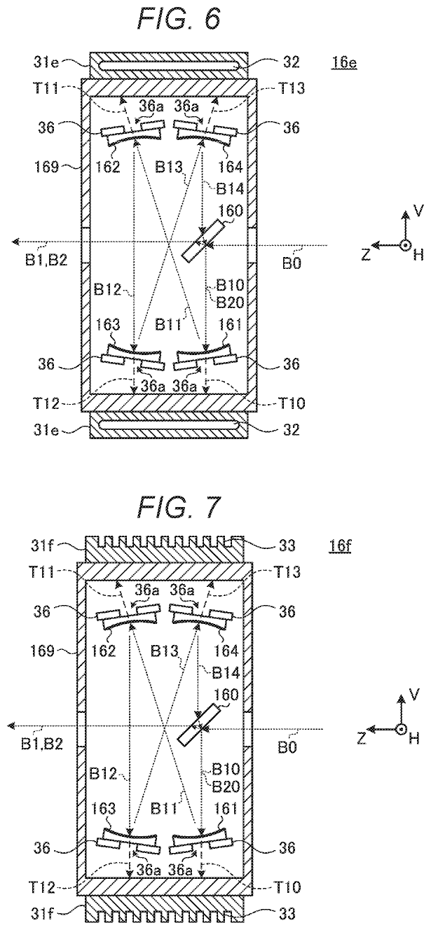

FIG. 6 schematically shows the configuration of an optical pulse stretcher 16e in a first example of a second embodiment of the present disclosure.

The transmitted light T10 to T13 passes through the through holes 36a of the holders 36 and is incident on the enclosure 169 of the optical pulse stretcher 16e in some cases. Upon the incidence of the transmitted light T10 to T13, the temperature of the enclosure 169 rises in some cases. In particular, the temperature rises at each of a bottom plate of the enclosure 169 that is the bottom plate that intersect extensions of the optical path axes of the first reflected light B10 and the reflected light B12 and a top plate of the enclosure 169 that intersect extensions of the optical path axes of the reflected light B11 and the reflected light B13. When the temperature of part of the enclosure 169 rises, the enclosure 169 is deformed, so that the positions or attitudes of the holders 36 and the first to fourth concave mirrors 161 to 164 held by the enclosure 169 change in some cases.

To eliminate the problem described above, a cooling plate 31e is attached to each of the bottom plate and the top plate of the enclosure 169 in the first example. A cooling medium channel 32 is provided as a cooling mechanism in each of the cooling plates 31e. Cooling water is supplied into the cooling medium channel 32, for example, via a cooling water pipe that will be described later. The cooling water having absorbed heat in the cooling medium channel 32 is discharged into the cooling water pipe. The bottom plate and the top plate of the enclosure 169 and the cooling plates 31e correspond to the light receiver in the present disclosure.

The light receiver that receives the transmitted light T10 to T13 is thus cooled, whereby the positions and attitudes of the first to fourth concave mirrors 161 to 164 are stabilized.

The other points are the same as those in the first embodiment. FIG. 6 shows the case where the through hole 36a is formed in each of the holders 36, and any of the through holes 36b to 36d described with reference to FIGS. 3 to 5 may instead be formed in each of the holders 36.

3.2 Case where Cooling Plates Each Including Heat Dissipating Fins are Attached to Enclosure

FIG. 7 schematically shows the configuration of an optical pulse stretcher 16f in a second example of the second embodiment of the present disclosure.

In the second example, a cooling plate 31f is attached to each of the bottom plate and the top plate of the enclosure 169. Heat dissipating fins 33 are provided as the cooling mechanism on the outer surface of each of the cooling plates 31f. The heat dissipating fins 33 form a large number of grooves, and the thus increased surface area as compared with a case where the grooves are not provided facilitates the heat dissipation. The bottom plate and the top plate of the enclosure 169 and the cooling plates 31f correspond to the light receiver in the present disclosure.

The light receiver that receives the transmitted light T10 to T13 is thus cooled, whereby the positions and attitudes of the first to fourth concave mirrors 161 to 164 are stabilized.

The other points are the same as those in the first example described with reference to FIG. 6.

3.3 Case where Cooling Plates Each Having Cooling Medium Channel are Disposed at Openings of Enclosure

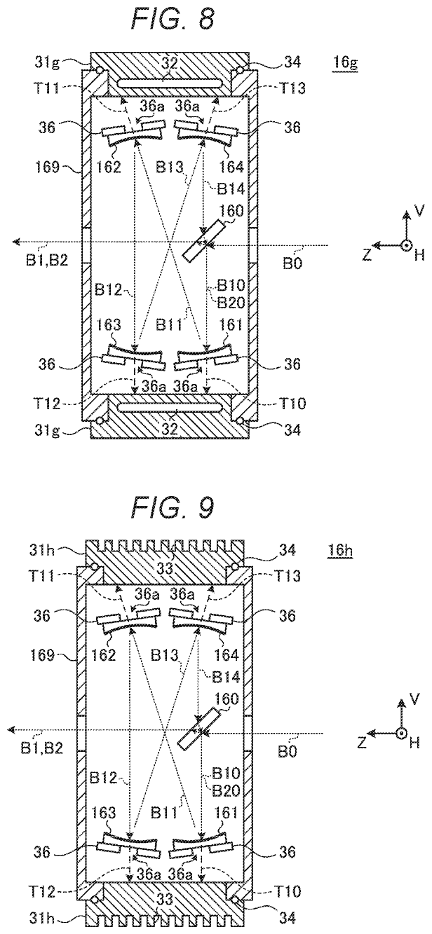

FIG. 8 schematically shows the configuration of an optical pulse stretcher 16g in a third example of the second embodiment of the present disclosure.

In the third example, an opening is formed in each of the bottom plate and the top plate of the enclosure 169, and a cooling plate 31g is disposed in each of the openings. The cooling plates 31g correspond to the light receiver in the present disclosure. 0 rings 34 are disposed between the enclosure 169 and the cooling plates 31g to hermetically close the openings of the enclosure 169.

The cooling medium channel 32 is provided in each of the cooling plates 31g. The cooling medium channels 32 are disposed in positions close to the inner surfaces of the cooling plates 31g in the thickness direction thereof that are the surfaces that the transmitted light T10 to T13 hits. The light receiver is thus efficiently cooled. The positions and attitudes of the first to fourth concave mirrors 161 to 164 are in turn stabilized.

The cooling plates 31g are made, for example, of a copper-based alloy, an aluminum-based alloy, or stainless steel (SUS). A copper-based alloy is particularly preferable because copper has high ultraviolet light absorptance and high thermal conductivity and is unlikely to deteriorate.

The other points are the same as those in the first example described with reference to FIG. 6.

3.4 Case where Cooling Plates Each Including Heat Dissipating Fins are Disposed at Openings of Enclosure

FIG. 9 schematically shows the configuration of an optical pulse stretcher 16h in a fourth example of the second embodiment of the present disclosure.

In the fourth example, an opening is formed in each of the bottom plate and the top plate of the enclosure 169, and a cooling plate 31h is disposed in each of the openings. The cooling plates 31h correspond to the light receiver in the present disclosure. The heat dissipating fins 33 are provided on the outer surface of each of the cooling plates 31h. The heat dissipating fins 33 form a large number of grooves, and the thus increased surface area as compared with a case where the grooves are not provided facilitates the heat dissipation.

The light receiver that receives the transmitted light T10 to T13 is thus cooled, whereby the positions and attitudes of the first to fourth concave mirrors 161 to 164 are stabilized.

The other points are the same as those in the third example described with reference to FIG. 8.

### 3.5 Cooling Plate Including Cooling Medium Channel and Optical Damper

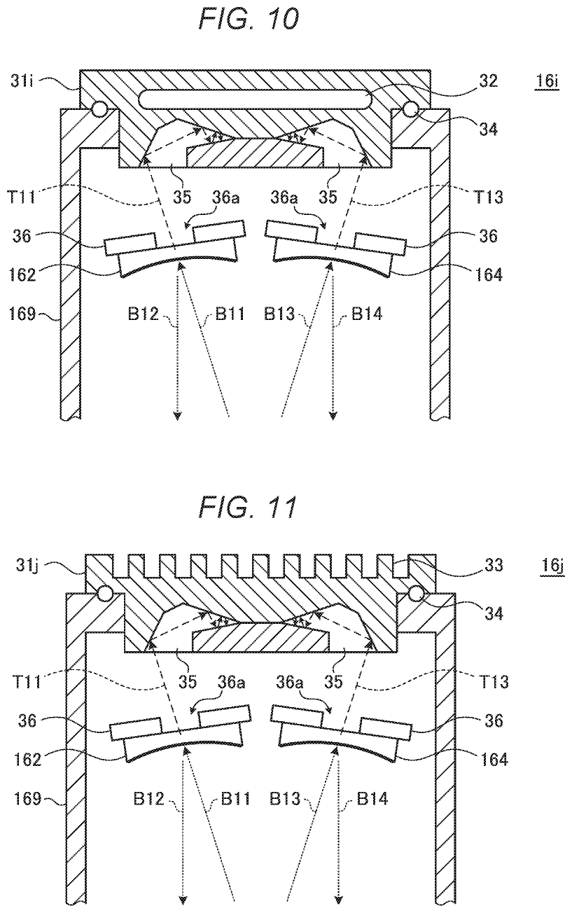

FIG. 10 schematically shows the configuration of part of an optical pulse stretcher 16i in a fifth example of the second embodiment of the present disclosure.

In the fifth example, an opening is formed in each of the bottom plate and the top plate of the enclosure 169, and a cooling plate 31i is disposed in each of the openings. The cooling plates 31i correspond to the light receiver in the present disclosure. An optical damper 35 is formed in each of the cooling plates 31i. The optical dampers 35 each have a groove having a width that decreases with distance toward the bottom. When the transmitted light T10 to T13 enters the groove, the transmitted light T10 to T13 is repeatedly reflected off and absorbed by the side surfaces of the groove and therefore attenuated. The cooling plates 31i can thus efficiently absorb the energy of the transmitted light T10 to T13.

The cooling plates 31i are cooled by the cooling mechanism each having the cooling medium channel 32.

The light receiver that receives the transmitted light T10 to T13 is thus cooled, whereby the positions and attitudes of the first to fourth concave mirrors 161 to 164 are stabilized.

The other points are the same as those in the third example described with reference to FIG. 8.

### 3.6 Cooling Plate Including Heat Dissipating Fins and Optical Damper

FIG. 11 schematically shows the configuration of part of an optical pulse stretcher 16j in a sixth example of the second embodiment of the present disclosure.

In the sixth example, an opening is formed in each of the bottom plate and the top plate of the enclosure 169, and a cooling plate 31j is disposed in each of the openings. The cooling plates 31j correspond to the light receiver in the present disclosure. The heat dissipating fins 33 are provided on the outer surface of each of the cooling plates 31j. The heat dissipating fins 33 form a large number of grooves, and the thus increased surface area as compared with a case where the grooves are not provided facilitates the heat dissipation.

The light receiver that receives the transmitted light T10 to T13 is thus cooled, whereby the positions and attitudes of the first to fourth concave mirrors 161 to 164 are stabilized.

The other points are the same as those in the fifth example described with reference to FIG. 10.

3.7 Case where Cooling Medium Channels are Formed in Enclosure

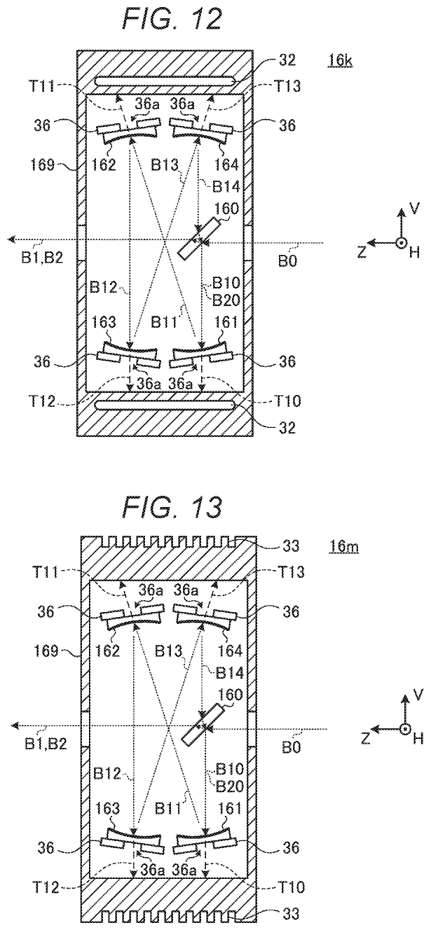

FIG. 12 schematically shows the configuration of an optical pulse stretcher 16k in a seventh example of the second embodiment of the present disclosure.

In the seventh example, the cooling medium channels 32 are formed in each of the bottom plate and the top plate of the enclosure 169. The bottom plate and the top plate of the enclosure 169 correspond to the light receiver in the present disclosure.

The light receiver that receives the transmitted light T10 to T13 is thus cooled, whereby the positions and attitudes of the first to fourth concave mirrors 161 to 164 are stabilized.

The other points are the same as those in the first example described with reference to FIG. 6.

3.8 Case where Heat Dissipating Fins are Formed on Enclosure

FIG. 13 schematically shows the configuration of an optical pulse stretcher 16m in an eighth example of the second embodiment of the present disclosure.

In the eighth example, the heat dissipating fins 33 are formed on the outer surface of each of the bottom plate and the top plate of the enclosure 169. The bottom plate and the top plate of the enclosure 169 correspond to the light receiver in the present disclosure. The heat dissipating fins 33 form a large number of grooves, and the thus increased surface area as compared with a case where the grooves are not provided facilitates the heat dissipation.

The light receiver that receives the transmitted light T10 to T13 is thus cooled, whereby the positions and attitudes of the first to fourth concave mirrors 161 to 164 are stabilized.

The other points are the same as those in the seventh example described with reference to FIG. 12.

### 3.9 Example of Cooling Water Pipe

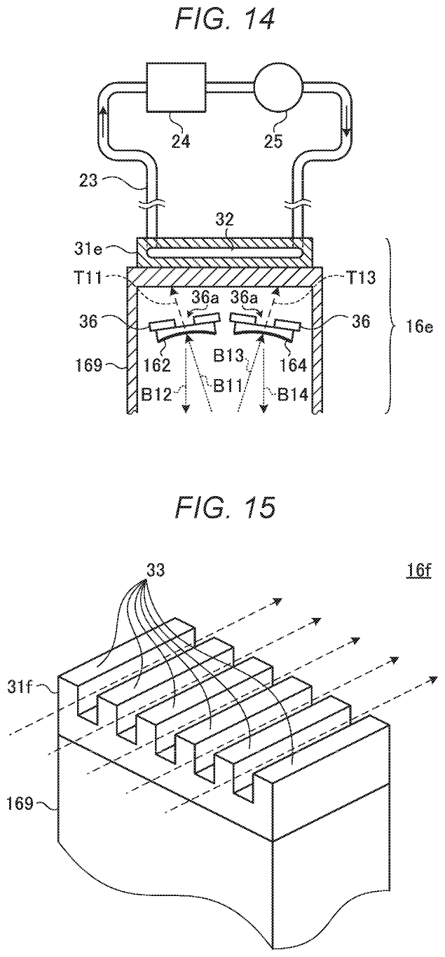

FIG. 14 schematically shows the configuration of the cooling water pipe used in the first, third, fifth, and seventh examples of the second embodiment of the present disclosure.

For example, a heat exchanger 24 and a pump 25 are disposed in a cooling water pipe 23 connected to each of the cooling medium channels 32. The heat exchanger 24 and the pump 25 may be provided outside the laser apparatus 1. The cooling water having absorbed heat in the cooling medium channel 32 is discharged into the cooling water pipe 23, and the heat is dissipated in the heat exchanger 24. The pump 25 then causes the cooling water to return to the cooling medium channel 32. The light receiver can thus be efficiently cooled.

### 3.10 Direction of Grooves Formed by Heat Dissipating Fins

FIG. 15 schematically shows the configuration of the heat dissipating fins in the second, fourth, sixth and eighth examples of the second embodiment of the present disclosure.

When the ventilator 22 described with reference to FIG. 1 produces the gas flow in the enclosure 20, the direction of the gas flow around the enclosure 169 is desirably substantially the same as the direction of the grooves formed by the heat dissipating fins 33. The gas thus flows without stagnation along the grooves formed by the heat dissipating fins 33, whereby the light receiver can be efficiently cooled. The ventilator 22 corresponds to the air cooling mechanism in the present disclosure.

### 4. Supplementation

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms unless otherwise described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An optical pulse stretcher comprising:
a separation optical element configured to separate pulsed laser light incident on a first surface thereof into first transmitted light and first reflected light;
a reflective optical system configured to guide the first reflected light to be incident on a second surface of the separation optical element that is a surface opposite the first surface; and
a holding member that has a through hole having an opening area smaller than an area of a reflective surface of a reflective optical element provided in the reflective optical system, is disposed on a rear side of the reflective optical element, and is configured to hold the reflective optical element.

2. The optical pulse stretcher according to claim 1,
wherein an opening section of the through hole has an opening width in a first direction greater than an opening width in a second direction perpendicular to the first direction.

3. The optical pulse stretcher according to claim 2,
wherein the opening section has a substantially oblong shape.

4. The optical pulse stretcher according to claim 3,
wherein the opening section has a substantially oblong shape having rounded corners.

5. The optical pulse stretcher according to claim 2,
wherein the opening section has a substantially elliptical shape.

6. The optical pulse stretcher according to claim 2,
wherein the through hole is an oval hole.

7. The optical pulse stretcher according to claim 1,
wherein the reflective optical system includes a plurality of reflective optical elements, and
the holding member is disposed on a rear side of each of the reflective optical elements.

8. The optical pulse stretcher according to claim 7,
wherein the holding member configured to hold a first reflective optical element that is one of the reflective optical elements has a first opening section having an opening width in a first direction greater than an opening width in a second direction perpendicular to the first direction,
the holding member configured to hold a second reflective optical element that is one of the reflective optical elements has a second opening section having an opening width in a third direction greater than an opening width in a fourth direction perpendicular to the third direction, and
the first direction and the third direction substantially coincide with each other.

9. The optical pulse stretcher according to claim 1, further comprising:
a light receiver so disposed as to intersect an extension of an optical path axis of the pulsed laser light incident on the reflective optical element; and
a cooling mechanism configured to cool the light receiver.

10. The optical pulse stretcher according to claim 9,
wherein the cooling mechanism has a cooling medium channel formed in the light receiver.

11. The optical pulse stretcher according to claim 9,
wherein the cooling mechanism includes a heat dissipating fin formed at the light receiver.

12. The optical pulse stretcher according to claim 9,
wherein the light receiver includes an optical damper.

13. A laser apparatus comprising:
a laser resonator;
a laser chamber disposed in the laser resonator and configured to accommodate a laser gas;
a pair of discharge electrodes disposed in the laser chamber; and
an optical pulse stretcher disposed in an optical path of pulsed laser light outputted from the laser resonator,
the optical pulse stretcher including
a separation optical element configured to separate the pulsed laser light incident on a first surface thereof into first transmitted light and first reflected light,
a reflective optical system configured to guide the first reflected light to be incident on a second surface of the separation optical element that is a surface opposite the first surface, and
a holding member that has a through hole having an opening area smaller than an area of a reflective surface of a reflective optical element provided in the reflective optical system, is disposed on a rear side of the reflective optical element, and is configured to hold the reflective optical element.

14. The laser apparatus according to claim 13,
wherein the holding member has the through hole having an opening area greater than a beam cross-sectional area of the pulsed laser light outputted from the laser resonator.

15. The laser apparatus according to claim 13, further comprising
an air cooling mechanism configured to produce a gas flow around an enclosure accommodating the optical pulse stretcher,
wherein heat dissipating fins forming grooves are formed at the enclosure accommodating the optical pulse stretcher, and
a direction of the gas flow produced around the enclosure by the air cooling mechanism coincides with a direction of the grooves.

16. The laser apparatus according to claim 13,
wherein the laser apparatus is an excimer laser apparatus configured to output pulsed laser light that belongs to an ultraviolet region.

17. A method for manufacturing an electronic device comprising:
producing pulsed laser light by using a laser apparatus;
outputting the pulsed laser light to a laser annealer; and
irradiating a substrate with the pulsed laser light in the laser annealer,
the laser apparatus including
a laser resonator,
a laser chamber disposed in the laser resonator and configured to accommodate a laser gas,
a pair of discharge electrodes disposed in the laser chamber, and
an optical pulse stretcher disposed in an optical path of the pulsed laser light outputted from the laser resonator,
the optical pulse stretcher including
a separation optical element configured to separate the pulsed laser light incident on a first surface thereof into first transmitted light and first reflected light,
a reflective optical system configured to guide the first reflected light to be incident on a second surface of the separation optical element that is a surface opposite the first surface, and
a holding member that has a through hole having an opening area smaller than an area of a reflective surface of a reflective optical element provided in the reflective optical system, is disposed on a rear side of the reflective optical element, and is configured to hold the reflective optical element.
